(19) United States
(12) Patent Application Publication
(10) Pub. No.: US 2025/0285439 A1
(43) Pub. Date: Sep. 11, 2025

(54) SYSTEMS AND METHODS FOR PLAYER TO TEAM ASSOCIATION BASED ON SPORTS VIDEO FEEDS

(71) Applicant: STATS LLC, Chicago, IL (US)

(72) Inventors: Vishnuvardhan GOPIREDDY, Proddatur (IN); Sateesh PEDAGADI, London (GB); Sagar HALESH, Channagiri (IN); Carlos Gallardo POLANCO, Cádiz (ES); Pradip GUPTA, Hyderabad (IN)

(73) Assignee: STATS LLC, Chicago, IL (US)

(21) Appl. No.: 19/071,111

(22) Filed: Mar. 5, 2025

Related U.S. Application Data
(60) Provisional application No. 63/638,997, filed on Apr. 26, 2024.

(30) Foreign Application Priority Data
Mar. 8, 2024 (IN) 202411016866

(51) Int. Cl. G06V 20/40; G06V 10/764; G06V 10/82

(52) U.S. Cl. CPC G06V 20/42; G06V 10/764; G06V 10/82

(57) ABSTRACT

A method for associating a player with a team in a sports event, the method including: receiving a video feed of a sporting event; identifying, based on an output of a first machine learning model, a patch of pixels corresponding to a player in a video frame of the video feed of the sporting event; determining, based on an output of a second machine learning model, a vector of the patch; retrieving gallery vectors for each team in the sporting event; determining a set of distances between the vector and each of the gallery vectors; and determining, based on a closest distance of the set of distances, a team identification for the player.

### CROSS-REFERENCE TO RELATED APPLICATIONS

This application claims the benefit of priority to Indian provisional application 202411016866, filed Mar. 8, 2024 and to U.S. Provisional Patent Application No. 63/638,997, filed Apr. 26, 2024, the entirety of each of which is incorporated by reference herein.

### TECHNICAL FIELD

Various aspects of the present disclosure relate generally to machine learning for sports applications, in particular various aspects relate to machine learning techniques for identifying players participating in a game and assigning or associating those players with a sports team.

### INTRODUCTION

The automatic assignment of or association of players with a particular sports team participating in a sports match within a video feed and/or broadcast setting may be particularly important for tracking, data collection, and other applications during monitoring of a sports game. These tasks are particularly important in computer-vision and machine learning applications where various factors affect the accuracy of the team assignments, including poor video encoding or video quality, player occlusion, officiating and other non-participating individuals, and similar appearances of players across different teams.

Unless otherwise indicated herein, the techniques and information described in this section are not prior art to the claims in this application and are not admitted to be prior art, or suggestions of the prior art, by inclusion in this section.

### SUMMARY

In some aspects, techniques described herein relate to a method for associating a player with a team in a sports event, the method including: receiving a video feed of a sporting event; identifying, based on an output of a first machine learning model, a patch of pixels corresponding to a player in a video frame of the video feed of the sporting event; determining, based on an output of a second machine learning model, a vector of the patch; retrieving gallery vectors for each team in the sporting event; determining a set of distances between the vector and each of the gallery vectors; and determining, based on a closest distance of the set of distances, a team identification for the player.

In some aspects, techniques described herein relate to a method, wherein the first machine learning model is a convolutional neural network.

In some aspects, techniques described herein relate to a method, wherein the patch of pixels of the player includes a player surrounding area, jersey, shorts, and player features.

In some aspects, techniques described herein relate to a method, wherein the second machine learning model is a classifier.

In some aspects, techniques described herein relate to a method, wherein the vector is normalized to have a score between 0 and 1.

In some aspects, techniques described herein relate to a method, wherein each of the gallery vectors for each team were determined by applying the second machine learning model to patches of pixels representing a player on each team prior to a beginning of the sporting event.

In some aspects, techniques described herein relate to a method, wherein the patch is of a portion of a player representing a jersey of the player.

In some aspects, techniques described herein relate to a method, wherein the method further includes: identifying, by implementing the first machine learning model, a second patch of pixels of the player in a video frame of the video feed of the sporting event, the second patch of pixels representing a subset of the player; determining, by implementing the second machine learning model, a second vector of the second patch; retrieving a second set of gallery vectors for each team in the sporting event; determining a second set of distances between the vector and each of the gallery vectors; wherein, determining the team identification of the player includes: averaging the set of distances and the second set of distances an determining a closest distance average.

In some aspects, techniques described herein relate to a method, wherein determining the set of distances between the vector and each of the gallery vectors includes applying a k-means nearest function to the vector and the gallery vectors.

In some aspects, techniques described herein relate to a method, further including: determining that the closest distance of the set of distances is under a threshold value to approve the team identification of the player.

In some aspects, techniques described herein relate to a method, wherein the retrieved gallery vectors for each team in the sporting event may be based upon lighting conditions in the from the video frame.

In some aspects, techniques described herein relate to a system for associating a player with a team in a sports event, the system including: a memory configured to store processor-readable instructions; and a processor operatively connected to the memory, and configured to execute the instructions to perform operations including: receiving a video feed of a sporting event; identifying, based on an output of a first machine learning model, a patch of pixels corresponding to a player in a video frame of the video feed of the sporting event; determining, based on an output of a second machine learning model, a vector of the patch; retrieving gallery vectors for each team in the sporting event; determining a set of distances between the vector and each of the gallery vectors; and determining, based on a closest distance of the set of distances, a team identification for the player.

In some aspects, techniques described herein relate to a system, wherein the first machine learning model is a convolutional neural network.

In some aspects, techniques described herein relate to a system, wherein the patch of pixels of the player includes a player surrounding area, jersey, shorts, and player features.

In some aspects, techniques described herein relate to a system, wherein the second machine learning model is a classifier.

In some aspects, techniques described herein relate to a system, wherein the vector is normalized to have a score between 0 and 1.

In some aspects, techniques described herein relate to a non-transitory computer readable medium configured to store processor-readable instructions, wherein when executed by a processor, the instructions perform operations including: receiving a video feed of a sporting event; identifying, based on an output of a first machine learning model, a patch of pixels corresponding to a player in a video frame of the video feed of the sporting event; determining, based on an output of a second machine learning model, a vector of the patch; retrieving gallery vectors for each team in the sporting event; determining a set of distances between the vector and each of the gallery vectors; and determining, based on a closest distance of the set of distances, a team identification for the player.

In some aspects, techniques described herein relate to a non-transitory computer readable medium, wherein the first machine learning model is a convolutional neural network.

In some aspects, techniques described herein relate to a non-transitory computer readable medium, wherein the patch of pixels of the player includes a player surrounding area, jersey, shorts, and player features.

In some aspects, techniques described herein relate to a non-transitory computer readable medium, wherein the second machine learning model is a classifier.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram of an environment for associating a player with a team in a sporting event, according to example embodiment.

FIG. 3 is a flow diagram of an exemplary method for associating a player with a team in a sporting event, according to example embodiments.

FIG. 4 is a flow diagram of an exemplary method for creating a vector representation of a gallery image, according to example embodiment.

FIG. 5 is a flow diagram of an exemplary method for training a color classifier, according to example embodiments.

FIG. 6 is a flow diagram of an exemplary method for associating a player with a team in a sporting event based on a previous team identification, according to example embodiments.

FIG. 7 is a flow diagram of an exemplary method for associating a player with a team in a sporting event while incorporating lighting conditions, according to example embodiments.

FIG. 8 displays light conditions for a frame of a sporting event, according to example embodiments.

FIG. 9A-9D displays variably light conditions for frames of a sporting event, according to example embodiments.

FIG. 10A-10I displays a frame of a sporting event and identified players in the frame, according to example embodiments.

FIG. 11A-11C displays a graph of model training for a machine learning system, according to example embodiments.

FIG. 12 is a flow diagram of an exemplary process for identifying a player associated with a team for a cropped portion of a player, according to example embodiments.

FIG. 13 is a flow diagram of a method for assigning a player to a particular team in a sporting event, according to example embodiments.

FIG. 14A-14B displays exemplary heat map graphs for a machine learning system, according to example embodiments.

FIG. 15 displays exemplary graphs for training, validation, and testing for a machine learning system, according to example embodiments.

FIG. 16A-16C displays exemplary metrics graphs for a machine learning system, according to example embodiments.

FIG. 17 depicts a flow diagram for training a machine-learning model, according to example embodiments.

FIG. 18A is a block diagram illustrating a computing device, according to example embodiments.

FIG. 18B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the present disclosure relate generally to techniques for machine learning for sports applications. For instance, certain aspects include the training of machine learning models and the utilization of computer vision techniques for identifying appearance data and/or reference data associated with a player and/or a sports team, wherein each player may be associated with a specific sports team.

Systems and techniques disclosed herein are directed to identifying players (e.g., using visual attributes of a video feed). Such identification may be used for various purposes such as player tracking for a sporting event. Such identification related tasks are often complicated where lighting conditions in a venue may change where, for example, the sun's position changes over the course of an outdoors sports match or the sun becomes occluded by cloud cover.

Some approaches for player tracking utilize a player's structure to assign or associate a particular player with a sports team, where such approaches may include the use of foreground and/or background extraction techniques. However, such approaches may be relatively inaccurate where, for example, lighting conditions change during a sports match or the video source includes external or background noise around a player.

Some systems may have implemented voxel classifiers to determine a player's respective team in a sporting event. The voxel classifier may lack the ability to consider the color of a respective player's jersey when assigning a player to a team. Consequently, the output may be inadequate, especially in different lighting conditions. Furthermore, reference images gather before a game may remain unchanged throughout the duration of the game. This system's classification may be rooted in voxels of the players, whereas the system described herein may rely on the color signal of players from a video feed. The system described herein may rely on exemplars (e.g., gallery images) of respective team players that may be used for comparison throughout the game. Further, the system may update reference exemplars throughout a live game.

According to systems and techniques disclosed herein, players may automatically be assigned a team (e.g., by a team identification classification). The techniques and approaches may overcome various factors such as poor encoding of videos, far side presence of occluded players due to objects (e.g., banners, overlays, etc.), similar appearances across players of different teams, and/or frequent occlusions amongst players.

According to systems and techniques disclosed herein, a player-team association model may utilize a combination of offline and online directory settings. A comprehensive set of reference samples, also referred to as gallery samples, representing various appearances of players may be used to select the nearest appearance during the configuration stage of processing a soccer game. The model may utilize these reference samples to conduct team association using, for example, a convoluted neural network for feature generation into a set number of classes (e.g., by color). The system may also be configured to capture and update an online reference gallery of samples from stable and high confidence matches to enable adapting the model to varying conditions in the game.

The system and techniques disclosed herein further address variable lighting conditions. As discussed herein, a model may segment a playing surface having multiple lighting regions and may utilize camera calibration to continuously update an area of the playing field based on player movement and changes to lighting conditions. The movement tracking may be used to classify the lighting condition for the player and utilize applicable reference data to associate the player with a given team.

According to techniques and systems disclosed herein, in comparison to using voxels of a given player, a player may be associated with a team based on a visual attribute (e.g., color signal) of the player. Such associations may depend on the reference data used to determine the associations. Reference data (e.g., cropped images of player visual attributes) may be updated with live instances of a given sporting event (e.g., based on a broadcast or in-venue feed). By implementing a moving gallery and light condition masks, team classification may be improved. Techniques and systems disclosed herein also include a refinement step to smoothen team classification based on the locations of players on a playing surface

While soccer and various aspects relating to soccer (e.g., a predicted total number of passes by a team during a game) are generally described in the present aspects as illustrative examples, the present aspects are not limited to such examples. For example, the present aspects can be implemented for other sports or activities, such as American football, basketball, baseball, rugby, hockey, cricket, golf, tennis, team sports, individual sports, and so forth.

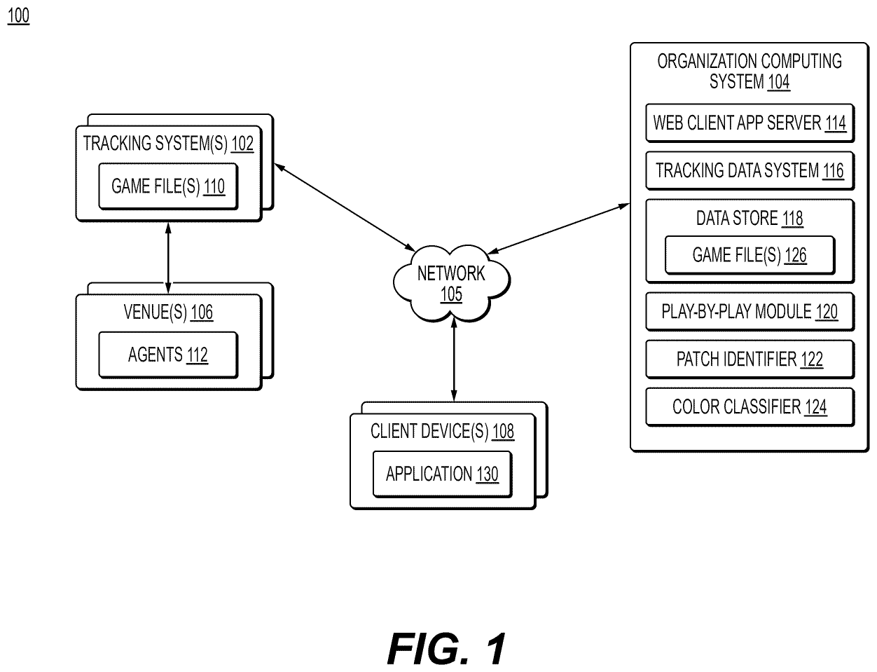

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105. In an example, environment 100 and its components identify player appearance data and compare appearance data against reference data associated with a team, generating a team identification for each player, wherein the team identification associates a player with a specific team identity. Additionally, environment 100 and its components calibrate appearance data and/or reference data based on identification of variable lighting conditions and tracking player position as lighting conditions change and as players move into or out of variable lighting conditions.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, patch identifier 122, and/or color classifier 124. Each of tracking data system 116, play-by-play module 120, patch identifier 122, and color classifier 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for color classifier 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

The environment may further include a patch identifier 122 and a color classifier 124. Each of the patch identifier 122 and the color classifier 124 may include one or more machine learning models.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

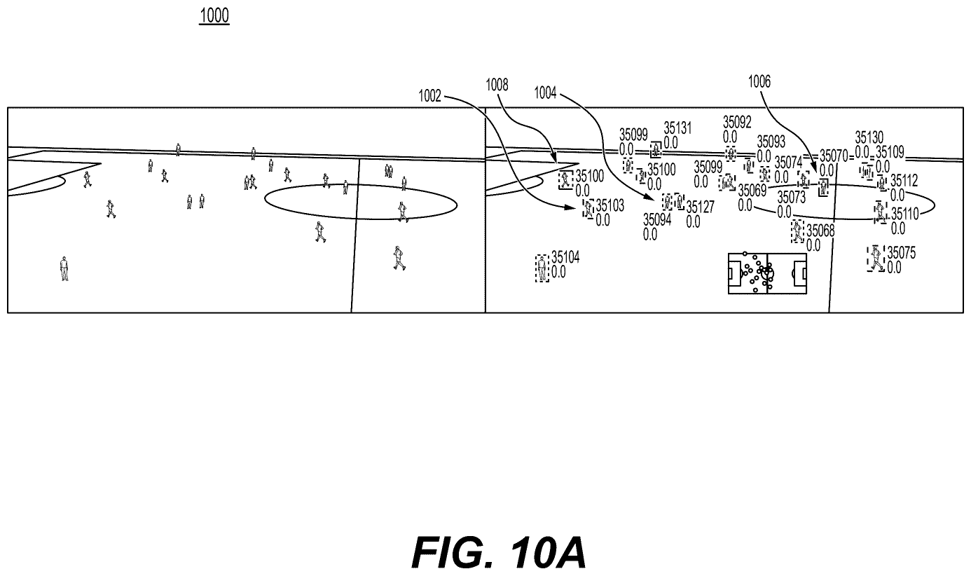

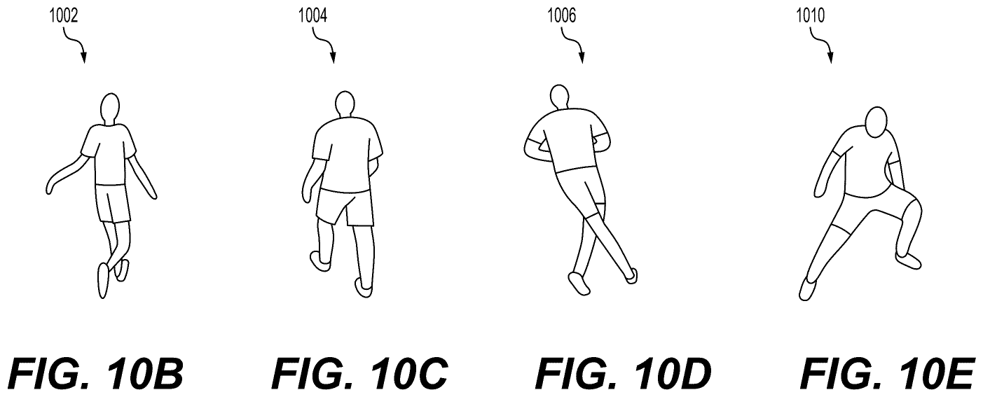

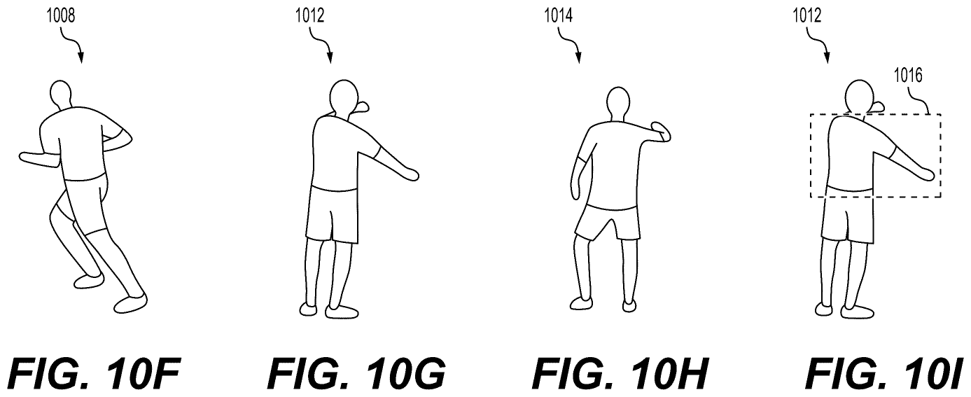

The patch identifier 122 may be configured to identify a set of pixels in a frame of a video or image that are of an individual. The patch identifier 122 may include an object detection model configured to identify a set of pixels represented by a rectangular frame of an individual in a sporting event. For example, the individuals may include field players, goalies, or referees in a soccer game. In some examples, the patch identifier 122 may incorporate a convolutional neural network (“CNN”) such as incorporate a ResNet 50 to identify the individuals. Examples of identified individuals in a sporting event may be depicted in FIG. 10B-10F discussed below.

The color classifier 124 may include a machine learning model configured to generate a vector from identified sets of pixels from the patch identifier 122. In some examples, this machine learning model may be implemented by a CNN. The generated vectors may include elements corresponding to different colors within the set of pixels. The color classifier 124 may further be configured to compare vectors to identify similar color patterns between sets of vectors. Through this comparison, the color classifier 124 may be configured to associate identified players with a respective team in a sporting event.

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format. The data store 118 may further be configured to store the generated vectors from the color classifier 124. The data store 118 may further include associations between stored vectors and team identification classifications.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to identify players in a sporting event through computing system 104. The content that is displayed to client device 108 may be transmitted from web client application server 114 to client device 108, and subsequently processed by application 130 for display through a graphical user interface (GUI) of client device 108.

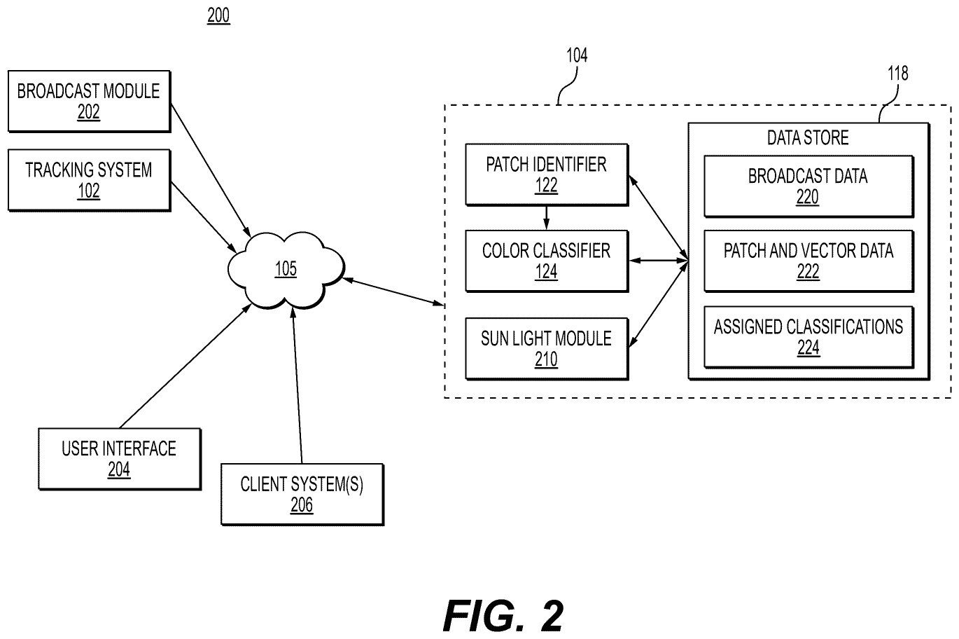

FIG. 2 is a block diagram of an environment 200 for associating a player with a team in a sporting event, according to example embodiment. The environment 200 may be configured to identify/associate a player with a team in a sporting event. The environment 200 may include a tracking system 102, a broadcast module 202, a user interface 204, a client system(s) 206, a network 105, and a computing system 104. The computing system 104 may include a patch identifier 122, a color classifier 124, a sunlight module 210 and a data store 118.

The broadcast module 202 may be configured to transfer a broadcast (both live or recorded) of sporting events to the computing system 104 through network 105. The broadcast module 202 may include a feed of one or more channels of sporting events. The broadcast module may further include internet based channels. The computing system 104 may further receive feeds and prerecorded videos from other sources. For example, a tracking system 102, a user interface 204 or a client system 206 may be configured to upload video feeds of a sporting event through network 105.

The user interface 204 may include one or more processors to select which videos to generate player identifications for. The client system 206 may include one or more servers utilized to access and retrieve identification determined by the environment 200.

The data store 118 may include broadcast data 220. The broadcast data 220 may include saved video files of sporting events. The broadcast data 220 may be analyzed by the environment 200. In some examples, the retrieved video feeds may be analyzed immediately as received (e.g., from the broadcast module 202).

As discussed above, the computing system 104 includes a patch identifier 122. The patch identifier 122 may be applied to an individual frame of a video to identifier sets of pixels that identify players. When a video is retrieved, the patch identifier may be the first component utilized to analyze the frames. The set of pixels may include a player surrounding area, player features, a jersey, and shorts. The patch may be in the shape of a rectangle or box. Example patches may be displayed in FIG. 10B-10F described below. The identified set of pixels identifying a player may be referred to as a patch. The determined patches may be saved in as patch data (e.g., patch and vector data 222) in the data store 118.

The color classifier 124 may be configured to determine a vector from the patch identified by the patch identifier 122. For example, the color classifier 124 may apply a machine learning model (e.g., a CNN) to determine a vector. The vector may include individual elements for a variety of colors identified within the patch. For example, the elements of the vector may correspond to scores for each of the colors. For example, the colors scored within the vector may include black, gray, white, dark blue, light blue, dark green, light green, dark purple, light purple, dark red, light red, dark yellow, light yellow and cyan. The determined vector may be utilized to describe the amounts of the respective colors within the patch. In some examples, the vector may be normalized to have scores for the elements from values 0 to 1. The determined vectors may be utilized by the computing system 104 to identify teams associated with players. The determined vectors from the color classifier 124 may be stored as patch and vector data 222 within the data store 118. Each vector determined may be associated with a patch determined from the patch identifier 122.

As will be discussed below, the computing system 104 may generate vectors (e.g., gallery vectors) utilizing the color classifier 124 for preidentified patches associated with teams in a sporting event. For example, prior to a game, set images (e.g., gallery images) of particular teams may be identified and patches may be created for them (e.g., through the patch identifier 122). The color classifier 124 may determine gallery vectors for the teams that may be stored in the patch and vector data 222. Each game may have a set of gallery vectors, including a gallery vector for each team in a sporting event. The five potential teams for a sporting event may include a home team, a home team goalie, an away team, an away team goalie, and a referee, each of which may have different assigned jerseys. Each of these teams may be assigned a team ID classifier. The home team may be assigned 0, the away team may be assigned 0, the referee may be assigned 2, the home team goalie may be assigned 3, and the away team goalie may be assigned 4. Each gallery vector from the set of gallery vectors may have an assigned team from the sporting events. In some examples, gallery vectors may be updated throughout a game. In some examples, a gallery vector may be created for each team in each identified lighting condition.

Throughout a video stream/feed, newly determined vectors may be compared to the gallery vectors to determine what team a player plays for. For example, a newly generated vector may be compared to each of the gallery vectors for a game, and a closest distance between the newly generated vectors and the gallery vectors may be identified. The identified gallery vector that has a closest distance may include an associated team, and the newly generated vector may be assigned a classification 224 relating to the team. This classification 224 may be stored in the data store 118. This classification may be referred to as a team identification classification. This classification 224 may be output to a user interface 204 or client system 206 for further processing.

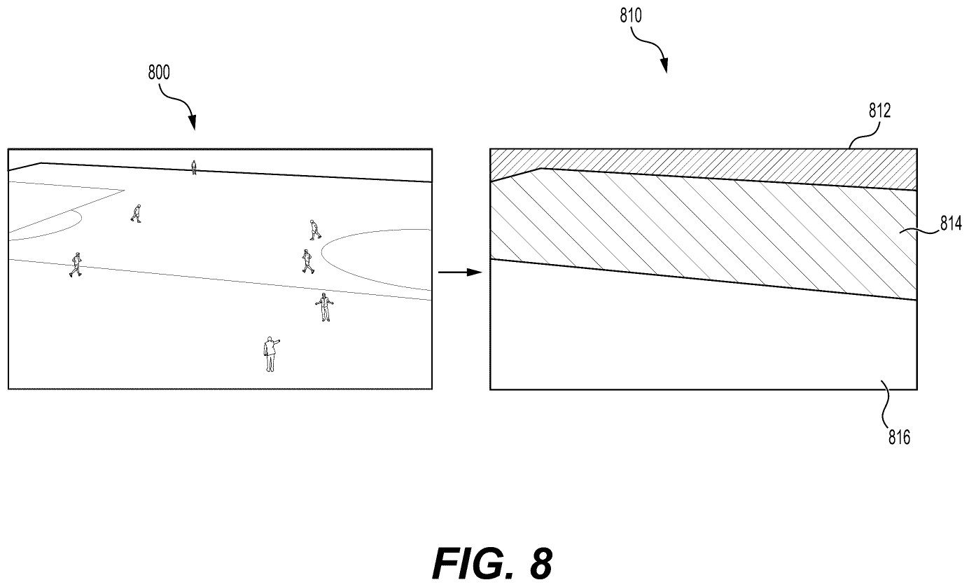

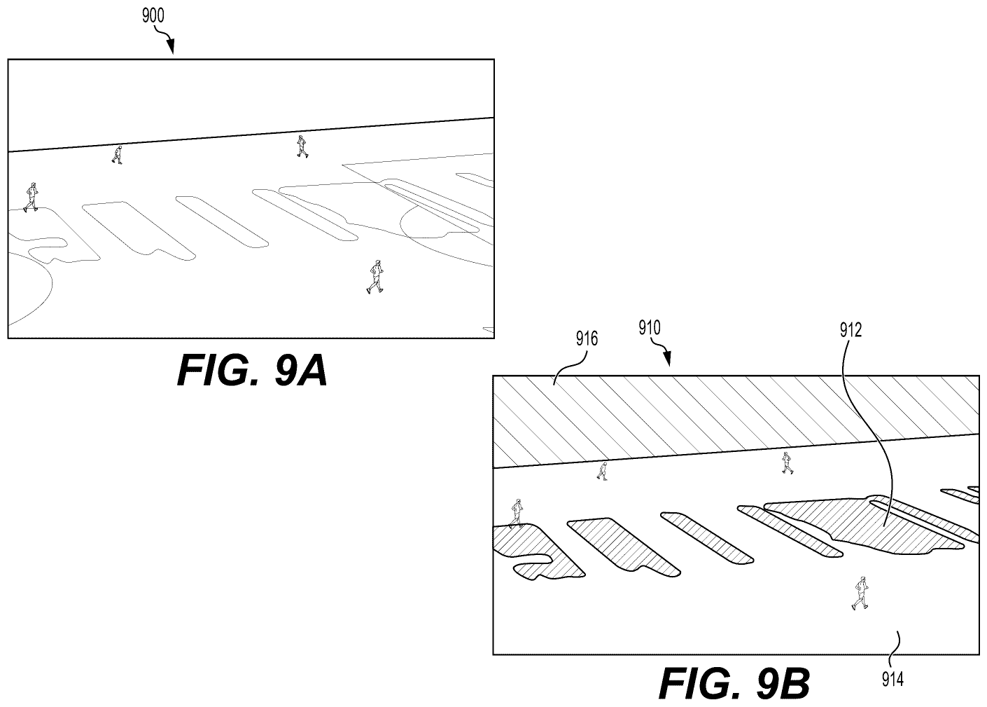

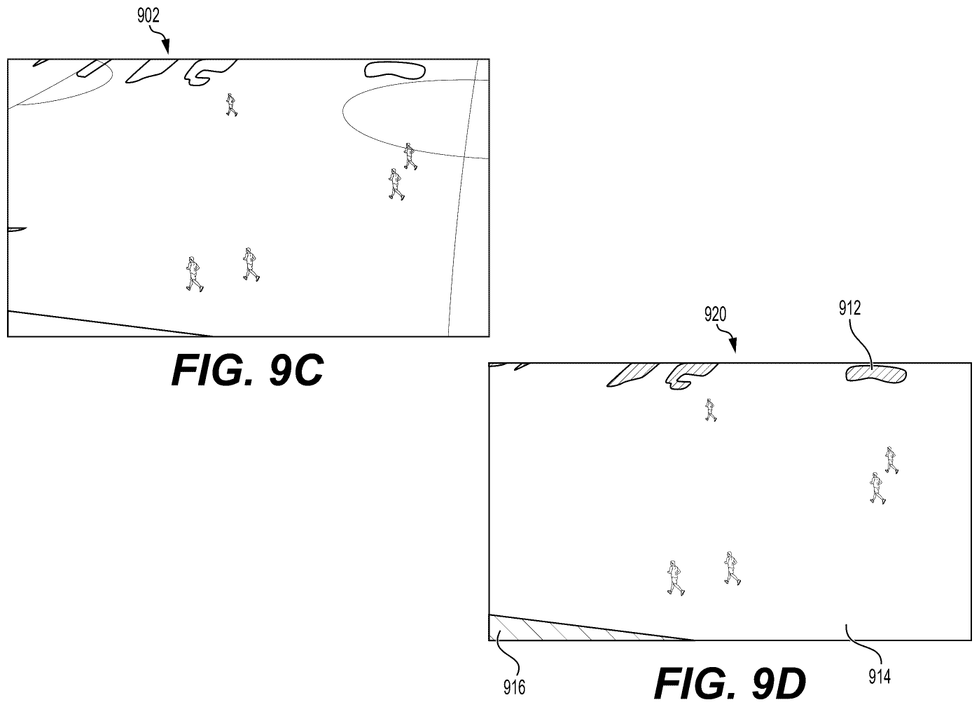

The computing system 104 may further include a sunlight module 210. The sunlight module 210 may be utilized to segment portions of a frame into classes of lighting. The sunlight module 210 may classify whether the frame has stable lighting conditions or sunny lighting conditions. The sunlight module 210 may be configured to generate sun-shadow masks for broadcast frames to segregate players in shadow portion for the pitch from players in sunny portions (e.g., semantic segmentation) for frames of a broadcast video. The sunlight module 210 may utilize a machine learning model to determine the sun-shadow masks. For example, the sunlight module 210 may utilize DeppLabv3+ResNett34 with auxiliary classifiers Using latest space) to identify the sun masks. Exemplary outputs of the sunlight module 210 may be displayed in FIG. 8-9D. The sunlight module 210 may implement Pytorch DataLoader and Albumentations Augmentations to upload data from the data store 118. In some examples, the sunlight module may implement the following composite loss:
0.6*CrossEntropyLoss (PredMask, LabelSmoothing=0.1)+\
0.2*DiceLoss (PredMask)+\
0.2*CrossEntropyLoss (PredLabel)

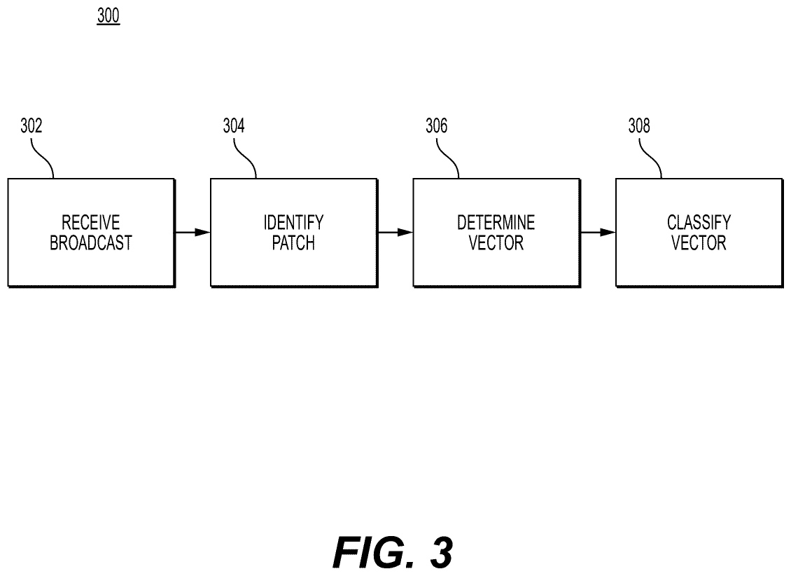

FIG. 3 is a flow diagram 300 of an exemplary method for associating a player with a team in a sporting event, according to example embodiments. The method of FIG. 3 may be implemented by environment 200 of FIG. 2.

Step 302 may include receiving a video feed of a sporting event. The video feed may be of a live sporting event or a prerecorded sporting event. The video feed may include additional data and/or additional associated data types, including tracking data from tracking system 102, or other data received from the video feed or resulting from preprocessing of the video feed. In some examples, the video feed may be received by the broadcast module 202 or by game files 110 of tracking system 102 of FIG. 2 and FIG. 1 respectively.

Step 304 may include identifying, based on an output of a first machine learning model (e.g., the patch identifier 122), a patch of pixels corresponding to a player in a video frame of the video feed of the sporting event. For example, the patch of pixels may be a cropping from a video frame of the video feed of step 302. The first machine learning model may be a convolutional neural network. The patch of pixels of the player may include a player surrounding area, jersey, shorts, and player features. The patch of pixels may be in the shape of a box or rectangle.

The patch of pixels may represent appearance data of the player in the sporting event. The appearance data may include visual attributes (e.g., kit or uniform color(s) associated with the individual player and/or goalkeeper of a sports team and/or referee official(s). It will be appreciated by one of ordinary skill in that art that the appearance data may include additional context-specific appearance data classifications dependent upon the type of sports event (e.g., American football, basketball, hockey, etc.) and may include, but is not limited to, accessory (e.g., hats, helmets, jerseys, etc.) markers, identifiers, and/or the like.

In some examples, the patches may be based on the aspect ratio of a bounding box identifying a player in the frame. For example, appearance segments (e.g., patches) may be segregated among different appearance elements, including shirt, trousers, hat, helmet, socks, shoes, or other sport-specific uniform elements. The patches may be created and/or updated without the need for foreground and/or background extraction techniques, where the patches are based on appearance aspects of a player. According to an embodiment, normalized patches may be generated based on composite information of a player or players visually detected based on a video feed. The normalized patches may be a combined color or other attribute of player jerseys (or other player related attribute) that include a plurality of different colors or attributes. For example, if a player jersey includes both blue and white, normalized appearance data may indicate a light blue color for players of that team (e.g., a combination of blue and white).

Step 306 may include determining, based on an output of a second machine learning model (e.g., color classifier 124), a vector of the patch. The second machine learning model may be a classifier. The elements of the vector may be normalized to have a score between 0 and 1.

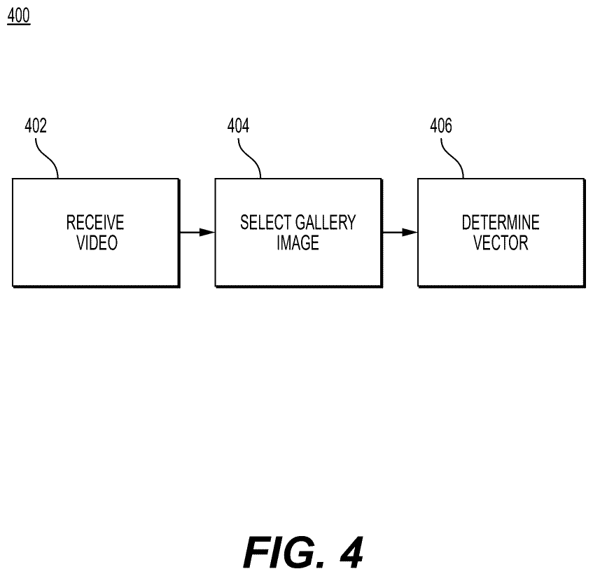

Step 308 may include classifying the vector. Classifying the vector may include steps to associate the player from step 304 with a team in the sporting event. Step 308 may include retrieving gallery vectors for each team in the sporting event. The method of FIG. 4 below may describe the process for determining gallery vectors and may be described in greater detail below.

Step 308 may include determining a set of distances between the vector and each of the gallery vectors. In some examples, a histogram techniques/algorithm may be applied to compare the vector with the gallery vectors. For example, this may include applying a k-means nearest function to the vector and the gallery vectors to determine the set of distances between the vector and each of the gallery vectors.

Step 308 may include determining, based on a closest distance of the set of distances, a team identification for the player. This may include determining that the closest distance of the set of distances is under a threshold value to approve the team identification of the player. Each gallery vector may include a team identification classifier, associating the particular gallery vector with a team. The team identification classifier of the closest gallery vector may be assigned to vector of step 306. This may allow for the player associated with the vector to be associated with a team identification classifier.

In an example, step 308 may include applying a histogram comparison between the vector and gallery vectors. The histogram comparison/matching may utilize one or more comparison thresholds for determining whether a sufficient match/correspondence exists between the vector and gallery vectors. The histogram matching techniques may be used to reduce the color spectrum options for the defined classes of comparison. For example, as the histogram matching increases in precision, the available color spectrum options will be reduced, allowing for more accurate and efficient matching/comparison as between appearance data and reference data

Steps 304 through 308 may be applied to frames throughout the video feed to associate players with a team in each frame of the video feed. The steps 304 through 308 may be applied simultaneously to multiple players in a video frame at once.

In some examples, steps 304-308 may be applied to a portion of the player in the video frame. For example, steps 304 and 308 may be applied twice for a single player, once to a patch of a top half of a player including the player's respective jersey and second to a patch including a player's trousers. For example, FIG. 10I described below includes a depiction of a first patch representing a player's jersey. In this example, a first vector representing a player's jersey may be determined and compared to a set of first gallery vectors representing the jersey of the teams in the sporting event. A second vector representing a player's trousers may be determined and compared to a set of second gallery vectors representing the trouser of the teams in the sporting event. Then, a first set of distances may be determined comparing the first vector to the set of first gallery vectors, and a second set of distances may be determined comparing the second vector to the set of second gallery vectors. The first set of distance and second set of distances may be averaged, and a smallest distance of the averages may be determined. This smallest average distance may be associated with a team (through the respective first gallery vector and second gallery vector).

FIG. 4 is a flow diagram 400 of an exemplary method for creating a vector representation of a gallery image, according to example embodiment. The method may be implemented by environment 200 of FIG. 2. The method of FIG. 4 may be applied prior to or during a sporting event to establish a set of gallery vectors for a sporting event.

Step 402 may include receiving a video feed of a sporting event. Step 404 may include selecting a gallery image. For example, a gallery image may be determined for each team in a sporting event. For example, in a soccer game a gallery image may be determined for a home team field player, a home team goalie, an away team field player, an away team goalie, and a referee. In other sports, a gallery image may be created for each unique jersey/color scheme of players in a sporting event.

The gallery image may be determined at the beginning of a game (e.g., during a national anthem). At the beginning of a game, teams may stand in preset orders (e.g., team players may stand together with refs in between), allowing for the system to automatically identify players with their respective teams. In some examples, a user may select gallery images from an early frame of the video feed. Selecting the gallery image may include cropping a set of pixels of a player in a frame of the video feed. In some examples, a classifier or machine learning model may automatically identify a gallery image. The selected gallery image may be referred to as a gallery patch.

In another example, steps 402 and 404 may include video feed and identifying patches from a previous game where a team wore the same outfits. In another example, patches of teams may be saved in a database (e.g., data store 118) and a user may select jerseys that correspond to a current game, and the system may automatically generate the gallery vectors corresponding to these jerseys.

Step 406 may include determining, utilizing a second machine learning model (e.g., color classifier 124), a gallery vector of each gallery patch. Step 406 may be the same process as step 306 of FIG. 3. Each gallery may be saved to a data store 118 (e.g., as patch and vector data 222). In one example, each gallery vector of a set of gallery vectors may include a team identification classifier. For example, a home player gallery vector may have a team ID classifier of 0, an away player gallery vector may have a team ID of 1, a referee gallery vector may have a team ID of 3, a home team goalie gallery vector may have a team ID of 4, and an away team goalie gallery vector may have a team ID of 4.

In some examples, the method of FIG. 4 may be applied to two portions of a player in the video feed. For example, sets of gallery vectors may be determined for both a trouser and a jersey patch of pixels for a player. In this case, the system may save two sets of gallery vectors (e.g., a first set of gallery vectors and a second set of gallery vectors) for a single game.

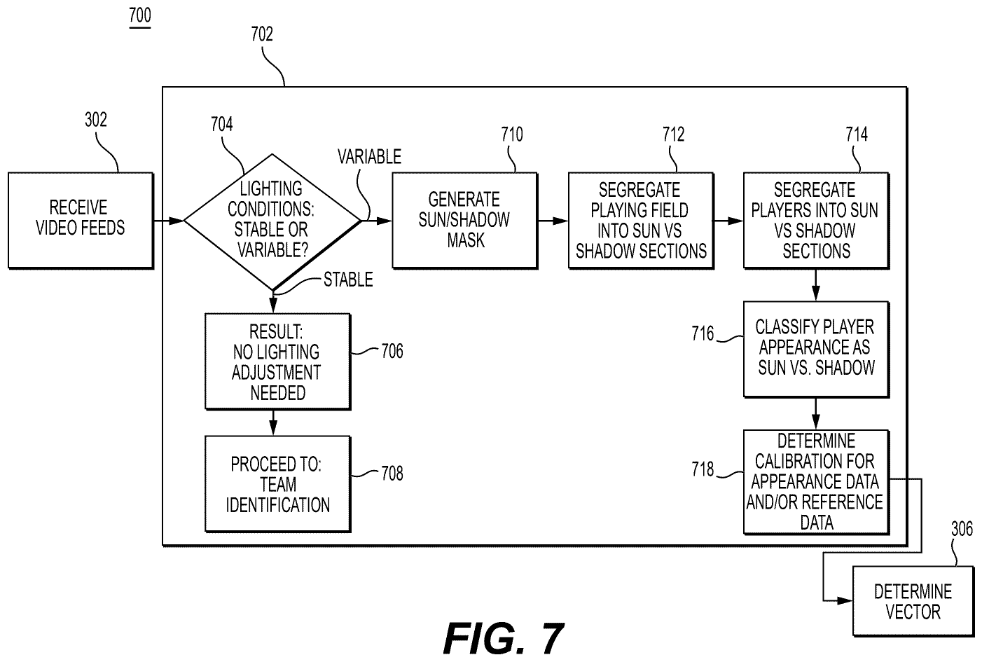

In some examples, the method of FIG. 4 may be reapplied to update gallery vectors throughout a sporting event. For example, if the lighting of a game changes (e.g., the sun sets during the sporting event), then the method may be reapplied to reset the gallery vectors during the game. The gallery vectors may be automatically and dynamically updated to reflect improved and varying conditions in the game (e.g., improved video feed/frame quality, improved lighting conditions, stabilized lighting conditions, or other data inputs that may inform the method steps) throughout the sporting event (e.g., by reapplying the method of FIG. 3). In some cases, each team may have multiple generated vectors in different lighting conditions or from different games all saved. For example, a gallery vector may be created for each team in each identified lighting condition. Each of these gallery vectors may be compared to vectors as described in the method of FIG. 3. In some examples (e.g., FIG. 7 described below), gallery vectors associated with particular lighting may be utilized when determining a team identification classification.

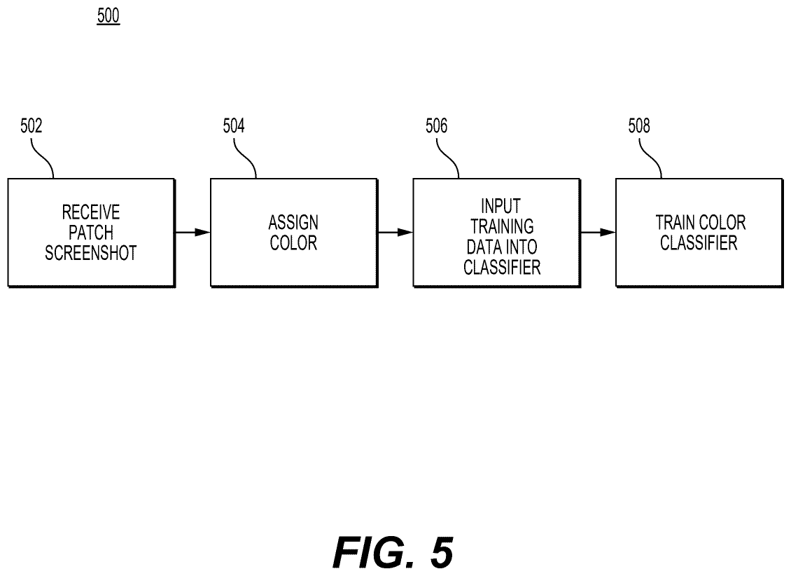

FIG. 5 is a flow diagram of an exemplary method 500 for training a color classifier, according to example embodiments. For example, the method 500 may be implemented to help train the color classifier 124 of FIG. 1 and FIG. 2.

Step 502 may include receiving patches of players from frames of a sporting event. The patches may have been cropped manually or may have been identified by applying the patch identifier 122.

Step 504 may include manually assigning colors to the patches. The assigned color may be the respective label for each patch. For example, the patches may be assigned a color of black, gray, white, dark blue, light blue, dark green, light green, dark purple, light purple, dark red, light red, dark yellow, light yellow or cyan. In some examples, the color association may be performed by previously trained model. The patches with assigned color data may be training data.

In some examples, step 502 and 504 may be skipped, and prelabeled patches may be received as training data. In some examples, the training dataset may be from patches of multiple sporting leagues and hundreds of sporting events.

Step 506 may include feeding the training data (e.g., the patches with labeled color) into the classifier model. Step 508 may include training the classifier model. This may include having the classifier make predictions and compare the predictions to the labels. The model then may be adjusted through backpropagation. In one example, the method of FIG. 5 may have been applied on over a hundred thousand samples of training data.

The method of FIG. 3 may be applied and run continuously or iteratively during the sports event to continuously update the team identification for a player based on stable and/or high confidences matches from step 308. According to this embodiment, movement of a player associated with team identification classification over a video feed may be tracked until a first point in time. At a second point in time, the tracking of such movement may stop (e.g., due to the player being occluded, due to the player being out of view in the video stream, etc.). At a third point of time (e.g., when the player is no longer occluded or is visible in the video stream), the player may be re-associated with the team identification classification in accordance with techniques disclosed herein.

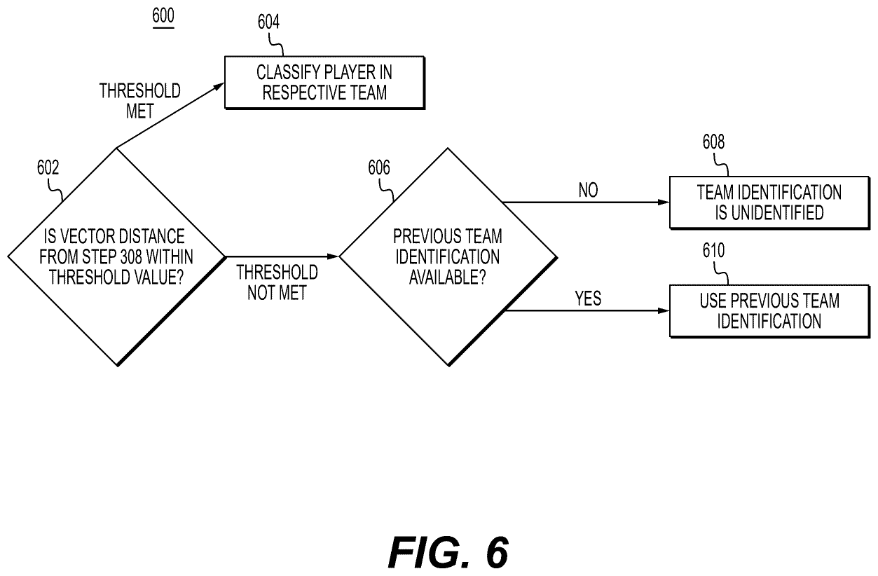

According to one embodiment, tracking data for each player may be utilized in conjunction with vectors to continuously associate a player with a specific team. This may be further described in FIG. 6 below. According to this embodiment, a vector associated with a team identification classification may be maintained while tracking data associated with the player is available. In response to a lapse in continuous tracking data of the player, the player may be disassociated with the existing association and may be re-associated with team identification classification when subsequent tracking data is available.

FIG. 6 is a flow diagram 600 of an exemplary method for associating a player with a team in a sporting event based on a previous team identification, according to example embodiments. The method of FIG. 6 may be implemented by environment 200 of FIG. 2.

Step 602 may include comparing a vector distance from step 308 to a threshold value. If the identified closest distance value is under a threshold value (e.g., the threshold is met), at step 604 the vector and player associated with the vector may be assigned a team classification identification. This may assign the player to a respective team in the sporting event.

At step 606, if the identified closest distance is above a threshold value (e.g., the threshold is not met), a previous team identification for the player may be searched for. For example, a search may be done based on tracking data to identify a previous team classification identification assigned to the player. If a previous identification is found, then this may be assisted at step 610. If previous identification is not found, then the player may not be assigned a team identification classification at step 608. In this case, the system may move on to the next player or next frame and apply the techniques described herein again.

In some examples, the method of FIG. 3 may further be adjusted to incorporate lighting conditions. FIG. 7 is a flow diagram 700 of an exemplary method for associating a player with a team in a sporting event while incorporating lighting conditions, according to example embodiments. The method of FIG. 7 may include all steps of FIG. 3 and an additional step 702 of adapting to lighting conditions, after receiving the video feed at step 302.

At step 702, upon identifying a frame in from the received video of step 302, the frame may be analyzed to determine whether the lighting conditions are variable or stable (e.g., by the sunlight module 210 of FIG. 2). If the lighting conditions are found to be stable (e.g., artificially lit venues, consistent direct sunlight, or indoor venues), the method may proceed to step 306 without any further processing in step 702 (e.g., the normal method of FIG. 3 may proceed). If the lighting conditions are found to be variable, the comparison of the vector and gallery vectors may be calibrated to account for such lighting variability. Similarly, the data input to create the vector and gallery vector may be calibrated to account for such lighting variability. Such an approach may utilize computer vision and/or machine learning techniques (e.g., by sunlight module 210 of FIG. 2) to continuously calibrate the camera and/or broadcast feed. Similarly, an approach may utilize such computer vision and/or machine learning techniques to continuously update the identified area of a venue (i.e., pitch or field) in which a player is or will be moving (i.e., player tracking) to classify whether the player appears in a sunny or shadow region of the venue.

For example, upon a determination of variable lighting conditions, a subset of gallery vectors may be selected that corresponds to the identified lighting conditions. This subset of gallery vectors may be utilized for players determined to be within the portion of the field subject to the identified lighting conditions. For example, upon a determination of the presence of sun and shadow regions of the field, a sun-shadow mask may be applied. Players (and their corresponding determined vectors) specifically associated within the shadow region, wherein the player is associated as being in a shadow region by tracking data, may have the vector compared with the shadow-associated gallery vectors when analyzing the player's appearance data for purposes of determining team identification classifications.

Machine learning models may be trained on historical tracking and identifications associated with different lighting conditions and/or tagged lighting attributes. These models may then be applied for selection of gallery vectors to be utilized according to different lighting conditions in a sports game

At step 704, the video frame identified at step 302 may be analyzed to determine whether the lighting conditions are stable or variable. At step 706, if lighting conditions are stable, no lighting adjustment may be needed, and at step 708, the method proceeds to step 306 to determine a vector associated with the player.

At step 710, if lighting conditions are variable, a sun/shadow mask may be generated for and/or applied to the playing field/pitch. This may be determined as output from the sunlight module 210. For example, the output may include a threshold value of whether a portion of the frame is sunny/non-sunny. In some examples, the threshold value may be approximately 0.8, where if the portion of the frame has an assigned variable above approximately 0.8, then it is considered shadow and if the portion of the frame is assigned a value of approximately 0.8 or lower, then the portion is considered sunny.

At step 712, the sun/shadow mask may be used to segregate the playing field into sunny sections and shadow sections. It will be appreciated that the sun/shadow mask and/or the segregation of sunny and shadow sections may be continually updated throughout the sports event where the sun and shadow sections may move or appear/disappear throughout the course of a sports event.

At step 714, player positions are segregated into those players located in sun sections and those players located in shadow sections. For example, this may be done by utilizing tracking data from the tracking system 102.

At step 716, based on whether a player is identified as being located in a sun section or in a shadow section, the player is classified as being associated with sunny lighting conditions or shadow lighting conditions, respectively.

At step 718, based on a player's classification in step 716, the system may later, at step 308, retrieve gallery vectors for the teams wherein the gallery vectors correspond to the identified lighting condition.

According to one embodiment, based on the analysis and calibration resulting from the method's adaptations to lighting conditions, the gallery vectors for each team may generated for both sun sections and shadow sections of the pitch. Having gallery vectors for each lighting condition may allow for accurate identification of correspondence between a player's vector and the gallery vectors, regardless of a player's position on the field/pitch during variable lighting conditions. According to an embodiment, a player movement may be tracked, and a prediction may be made regarding a future position of the player based on the tracked movement. Based on the prediction, a determination may be made that the player will be in a portion of a playing surface having a different lighting condition than a current lighting condition. Based on the predicted different lighting conditions, gallery vectors associated with the different lighting conditions may be queued and/or used for associating the player with a given team.

According to one embodiment, computer vision and/or machine learning techniques (e.g., tracking system 102) may be utilized to track and/or map player locations on a field/pitch to determine whether the player is in a sun section or a shadow section, wherein camera calibration is utilized to continuously update the area of pitch a player in which a player is moving and this movement is utilized to decide a classifier for either a sun section or a shadow section of a pitch. Although sun sections and shadow sections are provided as examples, it will be appreciated that other visual attributes may be determined for purposes of detecting and calibrating for factors and environments that may affect the visual and optical information obtained via camera, broadcast video feed, or other visual data.

FIG. 8 displays light conditions for a frame 800 of a sporting event, according to example embodiments. FIG. 8 displays an exemplary sun/shadow mask that may be created by the sunlight module 210. Frame 800 is an exemplary frame from a sporting event. The sun/shadow mask 810 may be created (e.g., by sunlight module 210) to segregate sections of the frame into different sun light categories. For example, section 816 may be sunny, section 814 may be shadowed, and section 812 may be identified as out-of-bounds (and not in the field).

FIG. 9A-9D displays variably light conditions for frames of a sporting event, according to example embodiments. These frames may display exemplary representation of adapting a video feed to variable lighting conditions, wherein a playing field is segregated into sun sections and shadow sections. FIG. 9A and FIG. 9C may show exemplary frames 900 and 902 from a sporting event. Then exemplary sun/shadow masks 910 and 920 are shown for the exemplary frames 900 and 902. Each of the sun/shadow masks 910 and 920 may include a sunny section 914, a shadow mask 912, and an out of bounds section 916. These sun/shadow masks may then be utilized with tracking data to determine whether a lighting with players on the field. The sun/shadow masks of FIG. 9A-9D may have been created by the sunlight module 210 of FIG. 2.

FIG. 10A-10I displays a frame 1000 of a sporting event and identified players in the frame, according to example embodiments. Frame 1000 may be an exemplary frame from a video feed of a sporting game. Frame 1000 may be an exemplary frame that may be analyzed to assign team identification classification according to the techniques described herein.

The frame 1000 of FIG. 10A may include a set of players, where the left side depicts a field with players, and the right side includes boxes surrounding identified players on the field (e.g., identified through the patch identifier 122). The frame 1000 may include home players 1002, away players 1004, a referee 1006, a home goalie 1010 (not shown in frame 1000) and an away goalie 1008. These individuals may further be displayed as an expanded view in FIG. 10B-10F. Further, FIG. 10G displays a player 1012 as depicted normally and FIG. 10H shows a player 1014 as depicted on a far side of a video frame. FIG. 10I shows a player 1012, where a bounding box 1016 has been applied to identify the shirt and trouser for the player. For example, the aspect ratio of the bounding box 1016 may be implemented to allow for separate color predictions for shirts and trousers of the player. The shirt separation may be depicted by a top ratio=0.15 and a bottom ratio=0.50.

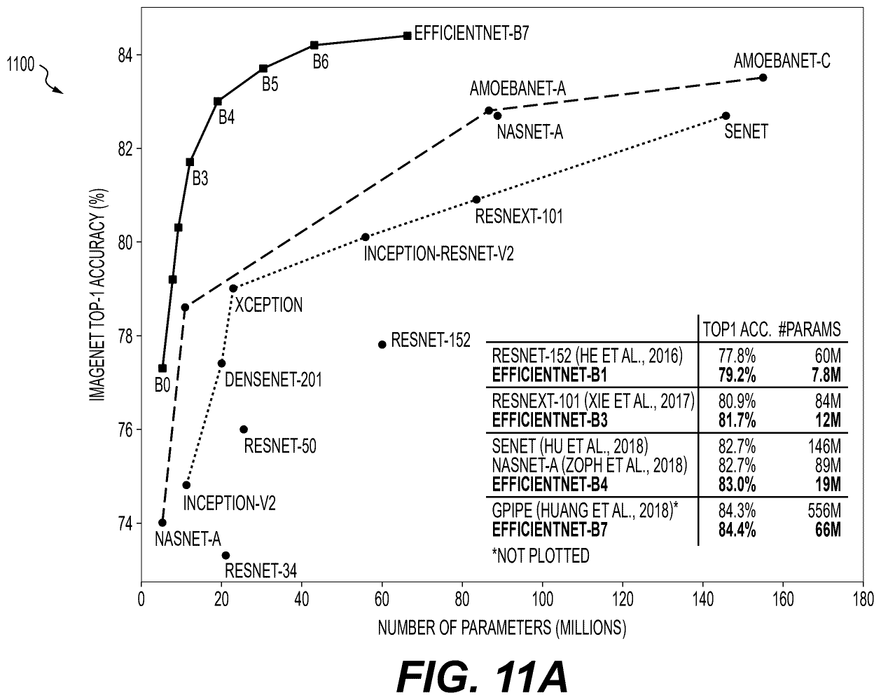

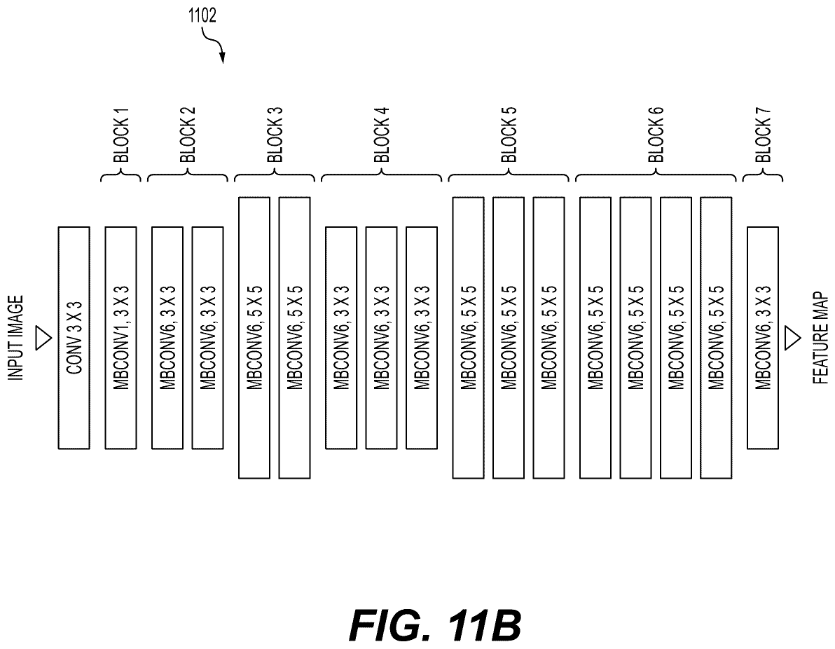

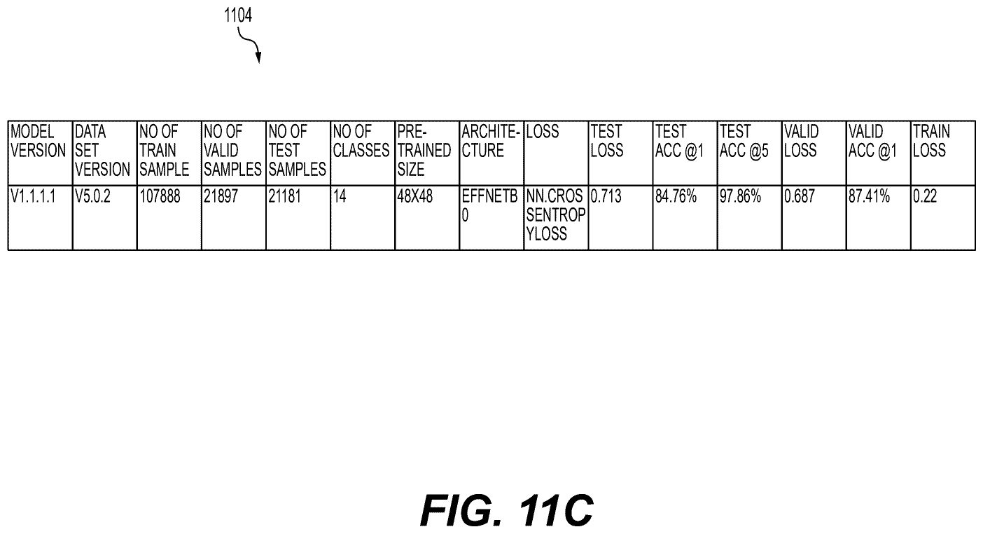

FIG. 11A-11C displays a graph 1100 of model training for a machine learning system, according to example embodiments. This may display the model training of the color classifier 124 described in FIG. 1 and FIG. 2. For example, efficientnet-b0 may be used to train the model, by using a multi-objective neural architecture that may optimize accuracy and floating point operations per second (“FLOPs”). The graph 1102 may display multi-objective neural architecture. Graph 1104 may depict exemplary results of training the model described herein.

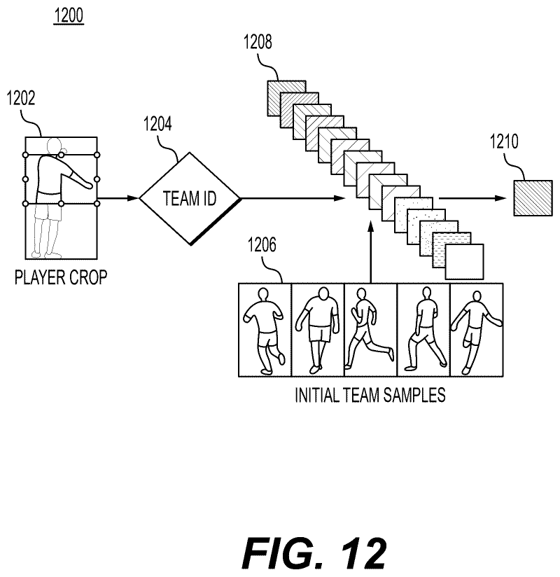

FIG. 12 is a flow diagram 1200 of an exemplary process for identifying a player associated with a team for a cropped portion of a player, according to example embodiments. Flow diagram 1200 may depict the methods and systems described herein. The flow diagram may show an exemplary player 1202 and a respective cropping that may be assigned a team identification classification 1204. The initial team samples 1206 may have been utilized to generate gallery vectors associated with team identification classifications 1204. The patch from player 1202 may be associated with one of a variety of colors 1208 by having a vector generated to classify the associated colors of the received patch. A vector 1210 representing the color of player 1202 may be output.

The model as described herein (e.g., color classifier 124) may be built using a combination of offline and online dictionary setting which is manual and automatic in nature respectively. A comprehensive set of samples representing various appearances of players may be used to select the nearest appearance by an operator during the configuration stage of processing a soccer game (e.g., to assist with generating gallery vectors). The model may utilize these exemplars to conduct team association using a CNN for feature generation into a set number of classes by color (14×). The system may also be capable of capturing and updating an online gallery (e.g., the gallery vectors) of samples from stable and high confidence matches to enable adapting the model to varying conditions in the game. Team classification may involve identifying the player's team based on the appearance of their kit, with a specific emphasis on training a Convolutional Neural Network (CNN) to precisely predict the color of the kit.

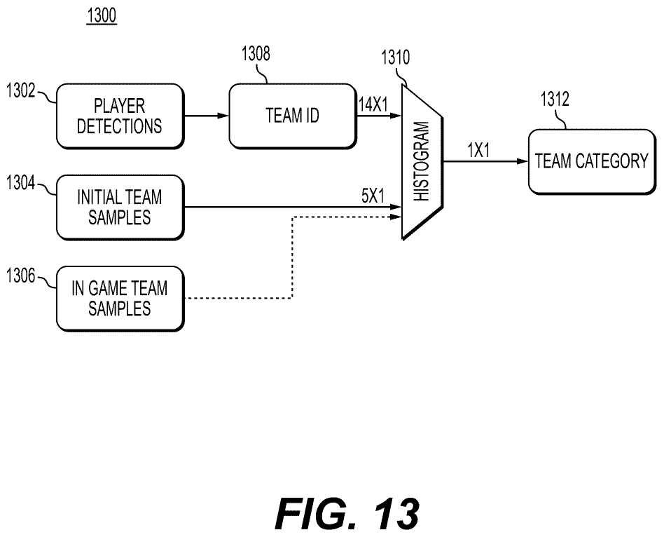

FIG. 13 is a flow diagram 1300 of a method for assigning a player to a particular team in a sporting event, according to example embodiments. This may include assigning a player identification classification to a player in a sporting event. For example, first player detection 1302 may occur, corresponding to step 304 of FIG. 3. Then either in game samples 1306 of gallery players or uploaded initial team samples 1304 may be retrieved to generate gallery vectors as described in FIG. 4. Next a team identification 1308 may be applied to the detected player from the first player detection 1302 (e.g., a vector was created) and compared through histogram techniques 1310 to the gallery vectors. This may lead to an outputted team category 1312 (e.g., a player identification classification).

To predict the probability of each color, a CNN model may have been trained. Additionally, it may have been observed that certain teams had different colors for their shirts and trousers. To address this, the shirt and trouser portions may have been cropped based on the aspect ratio of the bounding box. This may have for separate color predictions for shirts and trousers. To predict the winning team among five teams from the color model, a histogram comparison may be performed on five teams that were collected manually as reference samples

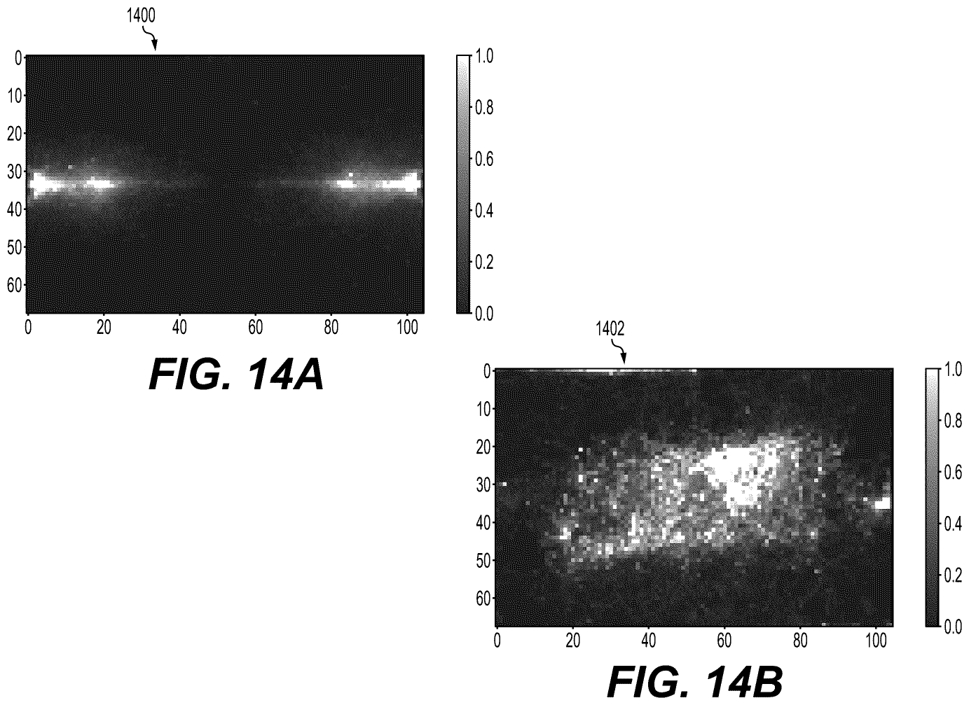

FIG. 14A-14B displays exemplary heatmaps 1400, 1402 for a machine learning system, according to example embodiments. The heatmap 1400 may be for a goalkeeper on a 2D pitch, which may be used to eliminate misidentification of referees and goal keepers. The heatmap 1402 may be for a referee on a 2D pitch. The system and method may describe track smothering algorithm based on 2d tracking of referees and goal keepers to help detect misidentifications. For example, majority voting may be taken across a given track to smoothen team identification classification. These smoothing techniques may be applied when predicting a team identification classification as described herein.

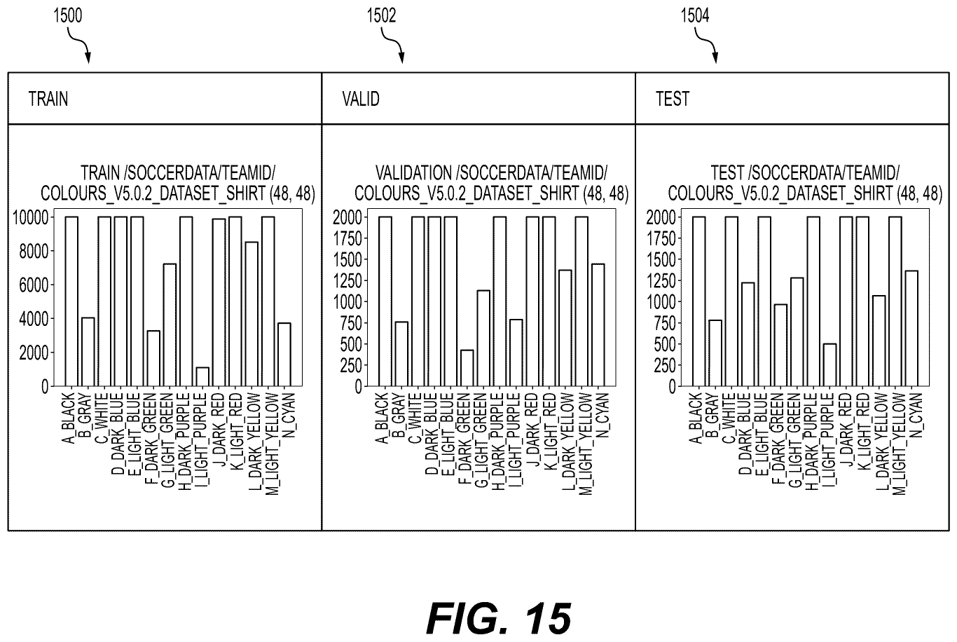

FIG. 15 displays exemplary graphs for training, validation, and testing for a machine learning system, according to example embodiments. Graph 1500 may represent the training of the color classifier 124, graph 1502 may represent the validation of the color classifier 124, and graph 1504 may represent the testing of the color classifier 124. In an exemplary case, the dataset used to train, validate, and test may have included data from multiple soccer leagues (e.g., four leagues) and many games (e.g., two hundred games). Within the dataset, fourteen distinct colors may have been identified. In an example, the sample may have been divided at a train/valid/test split of 70/15/15.

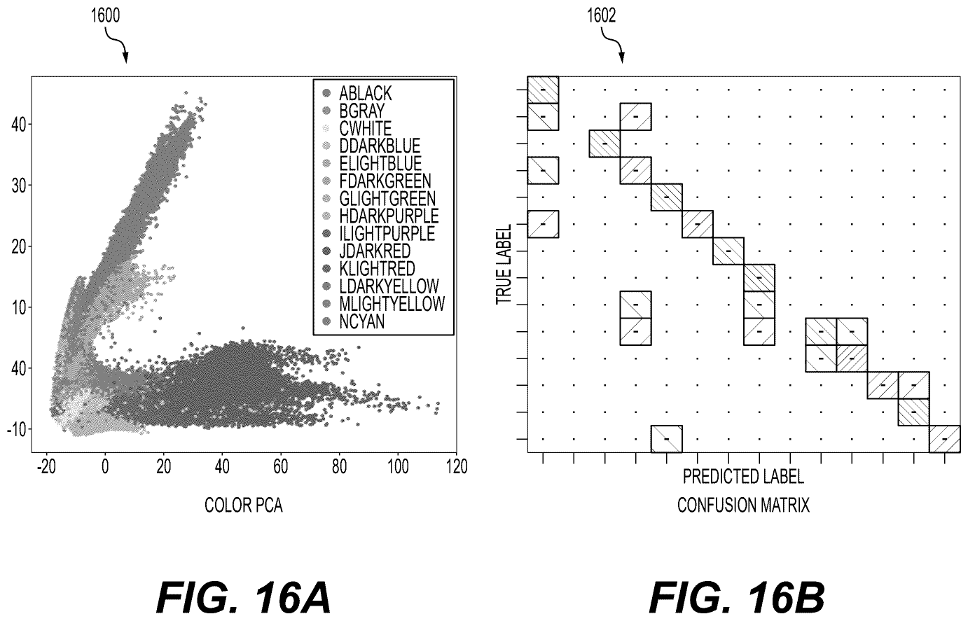

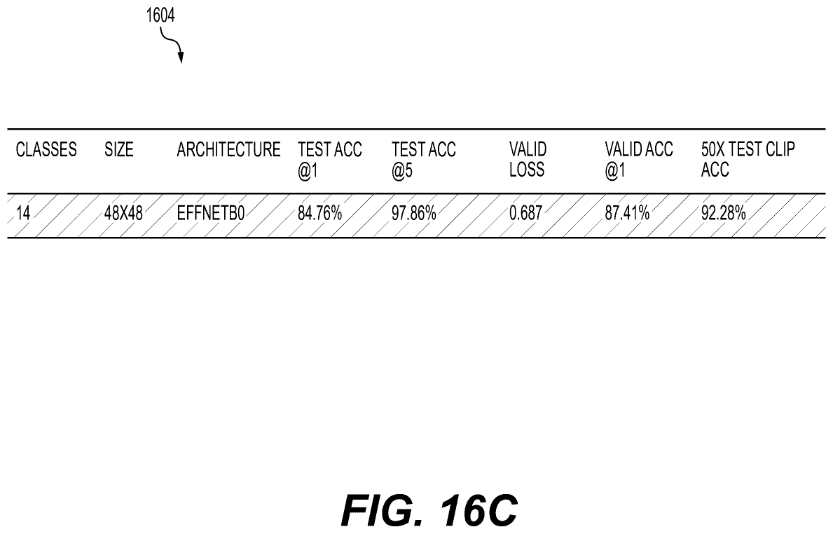

FIG. 16A-16C displays exemplary metrics graphs for a machine learning system, according to example embodiments. Graph 1600 may display a color principal component analysis (“PCA”) of colors found in the sample data utilized to train, validate, and test the color classifier 124. Graph 1602 may display a confusion matrix of the identified colors labeled by the color classifier 124. Graph 1604 may display a chart of the validation of the color classifier 124.

Examining reference images utilized for gallery vectors, these reference images play an important role in team classification/association of a player, wherein the accuracy may depend on how closely the reference samples/images resemble the actual appearance of the game. Instead of utilizing a static gallery that remains unchanged throughout the game, the present invention utilizes a dynamic gallery that continuously updates with reference images from the live sports game.

Because the team classification/association for players is based on the visual appearance of the game, this visual appearance may change as visual factors (e.g., lighting conditions) change during a game, leading to potential errors. To overcome this issue, sun and shadow models may be introduced to segment the playing field into sunny and shadowed regions, permitting more accurate predictions of player to team association. The reference data/images for each team are then updated with cropped visual appearances from both sunny and shadowed portions of the playing field.

In an additional refinement step, the positions and motions of the players on the playing field may be taken into consideration, where refinement of the model may be performed to smooth out the team classification/association process. These refinement rules help improve the accuracy of the predictions by considering the specific positions and/or motion of the players.

After implementing these improvements, the system described herein may have achieved a team classification/association accuracy rate of approximately 92%, signifying an important enhancement in the accuracy of predicting a winning team and/or other team or player data based on the appearance of the sports game.

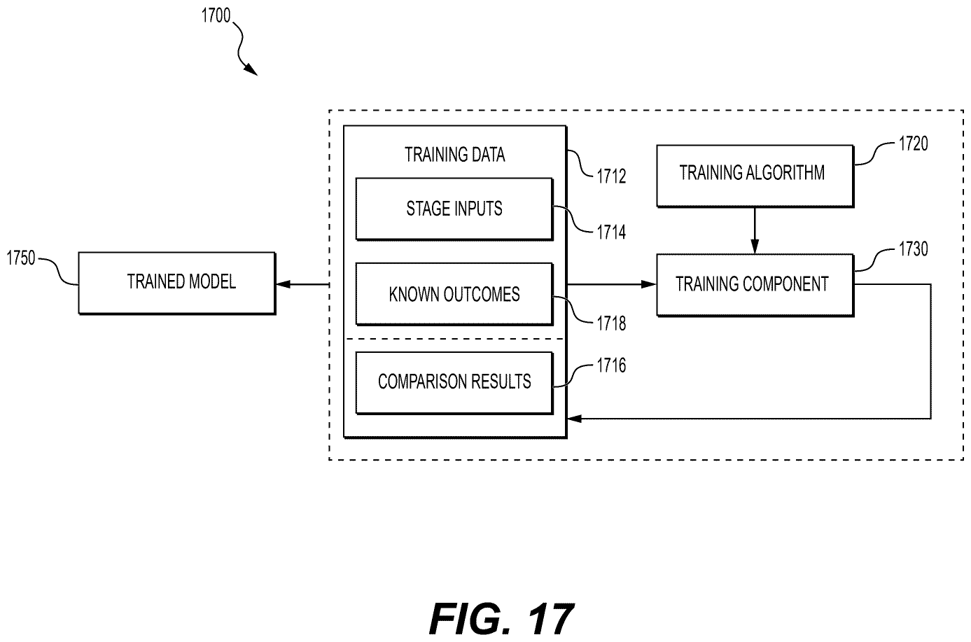

FIG. 17 depicts a flow diagram for training a machine learning model, in accordance with an aspect of the disclosed subject matter. As shown in flow diagram 1700 of FIG. 17, training data 1712 may include one or more of stage inputs 1714 and known outcomes 1718 related to a machine learning model to be trained. The stage inputs 1714 may be from any applicable source including a component or set shown in the figures provided herein. The known outcomes 1718 may be included for machine learning models generated based on supervised or semi-supervised training. An unsupervised machine learning model might not be trained using known outcomes 1718. Known outcomes 1718 may include known or desired outputs for future inputs similar to or in the same category as stage inputs 1714 that do not have corresponding known outputs.

The training data 1712 and a training algorithm 1720 may be provided to a training component 1730 that may apply the training data 1712 to the training algorithm 1720 to generate a trained machine learning model 1750. According to an implementation, the training component 1730 may be provided comparison results 1716 that compare a previous output of the corresponding machine learning model to apply the previous result to re-train the machine learning model. The comparison results 1716 may be used by the training component 1730 to update the corresponding machine learning model. The training algorithm 1720 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1700 may be a trained machine learning model 1750.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

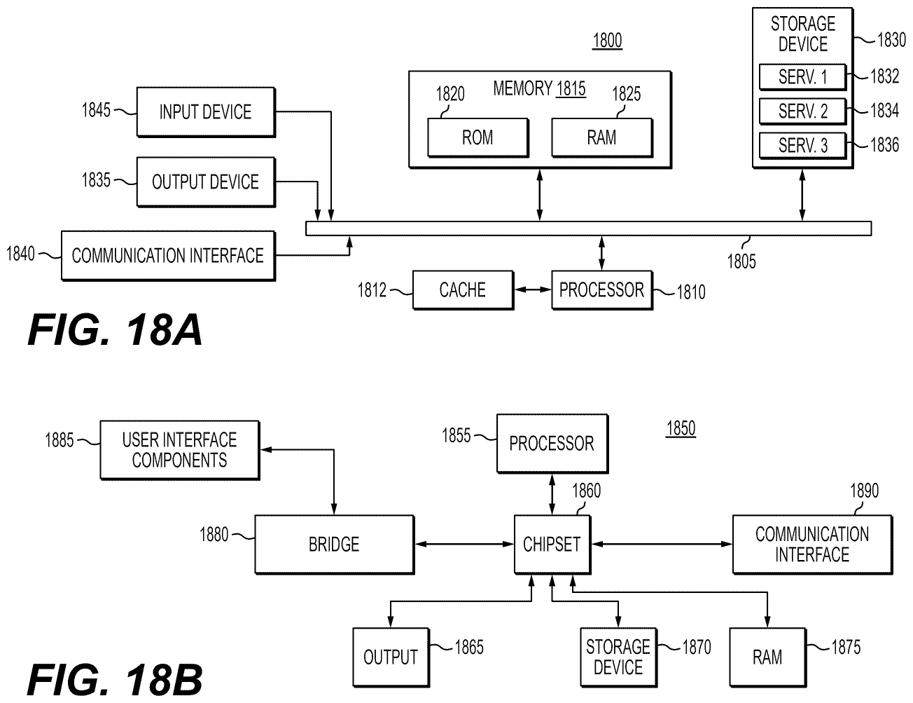

FIG. 18A illustrates an architecture of computing system 1800, according to example embodiments. System 1800 may be representative of at least a portion of organization computing system 104. One or more components of system 1800 may be in electrical communication with each other using a bus 1805. System 1800 may include a processing unit (CPU or processor) 1810 and a system bus 1805 that couples various system components including the system memory 1815, such as read only memory (ROM) 1820 and random access memory (RAM) 1825, to processor 1810. System 1800 may include a cache of high-speed memory connected directly with, in close proximity to, or integrated as part of processor 1810. System 1800 may copy data from memory 1815 and/or storage device 1830 to cache 1812 for quick access by processor 1810. In this way, cache 1812 may provide a performance boost that avoids processor 1810 delays while waiting for data. These and other modules may control or be configured to control processor 1810 to perform various actions. Other system memory 1815 may be available for use as well. Memory 1815 may include multiple different types of memory with different performance characteristics. Processor 1810 may include any general purpose processor and a hardware module or software module, such as service 1 1832, service 2 1834, and service 3 1836 stored in storage device 1830, configured to control processor 1810 as well as a special-purpose processor where software instructions are incorporated into the actual processor design. Processor 1810 may essentially be a completely self-contained computing system, containing multiple cores or processors, a bus, memory controller, cache, etc. A multi-core processor may be symmetric or asymmetric.

To enable user interaction with the computing system 1800, an input device 1845 may represent any number of input mechanisms, such as a microphone for speech, a touch-sensitive screen for gesture or graphical input, keyboard, mouse, motion input, speech and so forth. An output device 1835 (e.g., display) may also be one or more of a number of output mechanisms known to those of skill in the art. In some instances, multimodal systems may enable a user to provide multiple types of input to communicate with computing system 1800. Communications interface 1840 may generally govern and manage the user input and system output. There is no restriction on operating on any particular hardware arrangement and therefore the basic features here may easily be substituted for improved hardware or firmware arrangements as they are developed.

Storage device 1830 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1825, read only memory (ROM) 1820, and hybrids thereof.

Storage device 1830 may include services 1832, 1834, and 1836 for controlling the processor 1810. Other hardware or software modules are contemplated. Storage device 1830 may be connected to system bus 1805. In one aspect, a hardware module that performs a particular function may include the software component stored in a computer-readable medium in connection with the necessary hardware components, such as processor 1810, bus 1805, output device 1835, and so forth, to carry out the function.

FIG. 18B illustrates a computer system 1850 having a chipset architecture that may represent at least a portion of organization computing system 104. Computer system 1850 may be an example of computer hardware, software, and firmware that may be used to implement the disclosed technology. System 1850 may include a processor 1855, representative of any number of physically and/or logically distinct resources capable of executing software, firmware, and hardware configured to perform identified computations. Processor 1855 may communicate with a chipset 1860 that may control input to and output from processor 1855. In this example, chipset 1860 outputs information to output 1865, such as a display, and may read and write information to storage device 1870, which may include magnetic media, and solid-state media, for example. Chipset 1860 may also read data from and write data to RAM 1875. A bridge 1880 for interfacing with a variety of user interface components 1885 may be provided for interfacing with chipset 1860. Such user interface components 1885 may include a keyboard, a microphone, touch detection and processing circuitry, a pointing device, such as a mouse, and so on. In general, inputs to system 1850 may come from any of a variety of sources, machine generated and/or human generated.

Chipset 1860 may also interface with one or more communication interfaces 1890 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1855 analyzing data stored in storage device 1870 or RAM 1875. Further, the machine may receive inputs from a user through user interface components 1885 and execute appropriate functions, such as browsing functions by interpreting these inputs using processor 1855.

It may be appreciated that example systems 1800 and 1850 may have more than one processor 1810 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for associating a player with a team in a sports event, the method comprising:
receiving a video feed of a sporting event;
identifying, based on an output of a first machine learning model, a patch of pixels corresponding to a player in a video frame of the video feed of the sporting event;
determining, based on an output of a second machine learning model, a vector of the patch;
retrieving gallery vectors for each team in the sporting event;
determining a set of distances between the vector and each of the gallery vectors; and
determining, based on a closest distance of the set of distances, a team identification for the player.

2. The method of claim 1, wherein the first machine learning model is a convolutional neural network.

3. The method of claim 1, wherein the patch of pixels of the player includes a player surrounding area, jersey, shorts, and player features.

4. The method of claim 1, wherein the second machine learning model is a classifier.

5. The method of claim 1, wherein the vector is normalized to have a score between 0 and 1.

6. The method of claim 1, wherein each of the gallery vectors for each team were determined by applying the second machine learning model to patches of pixels representing a player on each team prior to a beginning of the sporting event.

7. The method of claim 1, wherein the patch is of a portion of a player representing a jersey of the player.

8. The method of claim 7, wherein the method further includes:
identifying, by implementing the first machine learning model, a second patch of pixels of the player in a video frame of the video feed of the sporting event, the second patch of pixels representing a subset of the player;
determining, by implementing the second machine learning model, a second vector of the second patch;
retrieving a second set of gallery vectors for each team in the sporting event;
determining a second set of distances between the vector and each of the gallery vectors;
wherein, determining the team identification of the player includes:
averaging the set of distances and the second set of distances a determining a closest distance average.

9. The method of claim 1, wherein determining the set of distances between the vector and each of the gallery vectors includes applying a k-means nearest function to the vector and the gallery vectors.

10. The method of claim 1, further including:
determining that the closest distance of the set of distances is under a threshold value to approve the team identification of the player.

11. The method of claim 1, wherein the retrieved gallery vectors for each team in the sporting event may be based upon lighting conditions in the from the video frame.

12. A system for associating a player with a team in a sports event, the system comprising:
a memory configured to store processor-readable instructions; and
a processor operatively connected to the memory, and configured to execute the instructions to perform operations comprising:
receiving a video feed of a sporting event;
identifying, based on an output of a first machine learning model, a patch of pixels corresponding to a player in a video frame of the video feed of the sporting event;
determining, based on an output of a second machine learning model, a vector of the patch;
retrieving gallery vectors for each team in the sporting event;
determining a set of distances between the vector and each of the gallery vectors; and
determining, based on a closest distance of the set of distances, a team identification for the player.

13. The system of claim 12, wherein the first machine learning model is a convolutional neural network.

14. The system of claim 12, wherein the patch of pixels of the player includes a player surrounding area, jersey, shorts, and player features.

15. The system of claim 12, wherein the second machine learning model is a classifier.

16. The system of claim 12, wherein the vector is normalized to have a score between 0 and 1.

17. A non-transitory computer readable medium configured to store processor-readable instructions, wherein when executed by a processor, the instructions perform operations comprising:
receiving a video feed of a sporting event;
identifying, based on an output of a first machine learning model, a patch of pixels corresponding to a player in a video frame of the video feed of the sporting event;
determining, based on an output of a second machine learning model, a vector of the patch;
retrieving gallery vectors for each team in the sporting event;
determining a set of distances between the vector and each of the gallery vectors; and
determining, based on a closest distance of the set of distances, a team identification for the player.

18. The non-transitory computer readable medium of claim 17, wherein the first machine learning model is a convolutional neural network.

19. The non-transitory computer readable medium of claim 17, wherein the patch of pixels of the player includes a player surrounding area, jersey, shorts, and player features.

20. The non-transitory computer readable medium of claim 17, wherein the second machine learning model is a classifier.
